(19) United States
(12) Patent Application Publication
(10) Pub. No.: US 2017/0319923 A1
(43) Pub. Date: Nov. 9, 2017

(54) METHOD AND SYSTEM FOR CLEANING AND RESTORING A GOLF CLUB GRIP

(71) Applicant: Kevin Knordenstrom, Aptos, CA (US)

(72) Inventor: Kevin Knordenstrom, Aptos, CA (US)

(21) Appl. No.: 15/149,100

(22) Filed: May 7, 2016

(51) Int. Cl. A63B 60/36; B08B 3/08; B08B 1/00

(52) U.S. Cl. CPC A63B 60/36; B08B 1/002; B08B 3/08

(57) ABSTRACT

A method and system used to periodically clean dirt and oils deposited through normal use from the grip of a golf club and renew it to a near new condition is disclosed. The system for cleaning and restoring a golf club grip of a golf club comprises a generally elongated housing having a hinge for splitting open the housing lengthwise wherein an interior of said housing defines retaining channels and a generally tapered and trapezoidal cleaning and restoring device defining an elongated centrally located ridge along a top of said device. In use, the device is placed into the housing by inserting the device ridge into the housing channel for holding the device during use wherein the housing defines a latch allowing the housing to close shut and hold a golf club grip in place during use with the device.

### FIELD OF THE INVENTION

The present invention relates to a method and system for cleaning and restoring grips of sports equipment and more particularly for cleaning and restoring a golf club grip.

### BACKGROUND OF THE INVENTION

In the case of golf, clean grips are essential and a major factor contributing to the player's success at the game. For a professional golfer, dirty, grimy, oily, perspiration-soaked golf club grips are the quickest way to high scores wherein a mishit of the golf ball during a golf swing is likely to result, no matter the skill level of the player. Soiled grips also force the golfer to grasp their golf club tighter or overcompensate in other parts of their swing, resulting in even more mishits and less confidence in their ability to play the game of golf. That is why most professional golf caddies clean their player's grips after every shot. However, most golfers do not have the luxury of a professional caddie.

Many types of golf club grip cleaners are known from disposable wipes with special cleaning solutions such as U.S. Pat. No. 7,055,534 (Goode et al.) entitled “Golf grip cleaning wipe” to devices with scouring brushes or pads, such as U.S. Pat. No. 6,269,512 (Thomson et al.) entitled “Grip washer”. Brush-type golf club grip cleaners/washers used to remove debris, grime, and other foreign matter from golf club grips generally come in two types: 1) portable, and 2) stationary. Stationary, brush-type golf grip cleaners, such as Thomson et al., are intended to be secured to a fixed location—some even requiring electrical power operation, such as U.S. Pat. No. 4,676,839 (Osborn) entitled “Golf club grip cleaner”, and do not meet the practical requirements of golfers who need to clean their golf club grips (at any time or anywhere) while playing or practicing the game of golf. Stationary golf club grip cleaners are also intended for common or public use, thus potentially contributing to the spread of germs and disease if the water/solution is not replaced after every use. While some stationary golf grip cleaning devices employ multiple circular brushes located at a common distance from a central axis so that brushes' working surfaces do not conform to the configuration of a golf club grip, such as Osborn, most stationary golf grip washers/cleaners have doughnut-shaped brush rings with bristles that radiate inwards from the cylindrical wall of an elongated tubular housing.

One example of a portable, brush-type golf grip cleaner is U.S. Pat. No. 5,269,615 (Lewis Jr.) entitled “Grip cleaning device”, which is hand-held and has an open-ended, single elongated housing. As with most stationary golf grip cleaners, the Lewis device uses doughnut-shaped brush rings with bristles that radiate inwards from a cylindrical housing base to form a smaller diameter circular cavity or working surface. Other devices, such as U.S. Pat. No. 4,923,316 (Fattal) entitled “Golf club cleaning device” uses pads. The Fattal device is intended specifically for use on golf club grips, while the Lewis device is intended to clean a variety of sports equipment handles and racket grips. These devices also differ with respect to their working surfaces. Lewis' invention provides a “non-replaceable mat of synthetic filament tufts radiating inward from a thin molded base, trimmed to form a working surface which coincides with the external surface of the object to be cleaned” into which a sports equipment grip is inserted, moved up and down, and cleaned. The Fattal device uses a sponge rubber material having an outer emery cloth layer.

Therefore, a need exists for a golf grip cleaner that allows for the easy and portable use of brushes and pads and to the delivery of water or cleaning solutions to the working surfaces of the brushes when cleaning and/or restoring a golf club grip. The present invention solves this problem in a unique and novel manner.

### SUMMARY

A method and system that is used to periodically clean dirt and oils deposited through normal use from the grip of a golf club that result in a less than desirable grasp of the grip and renew it to a near new condition is disclosed. The system for cleaning and restoring a golf club grip of a golf club comprises a generally elongated housing having a hinge for splitting open the housing lengthwise wherein an interior of said housing defines retaining channels and a generally tapered and trapezoidal cleaning and restoring device defining an elongated centrally located ridge along a top of said device. In use, the device is placed into the housing by inserting the device ridge into the housing channel for holding the device during use wherein the housing defines a latch allowing the housing to close shut and hold a golf club grip in place during use with the device. The device is an insert cleaning brush for cleaning a golf grip and a restoring insert pad for restoring a golf club grip.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

In the accompanying drawings:

FIG. 1 is a top plan view of the golf grip cleaning/restoring handle and enclosure in an open position in accordance with the present invention;

FIG. 2 is a front view of the golf grip cleaning/restoring handle and enclosure shown in FIG. 1 in a closed position according to the present invention;

FIG. 3 is a front view of the closure clasp of the golf grip cleaning/restoring handle and enclosure according to the present invention;

FIG. 4 is a bottom view of a cleaning brush for use in the golf grip cleaning/restoring handle and enclosure shown in FIG. 1 according to the present invention;

FIG. 5 is a top view of the cleaning brush shown in FIG. 4 according to the present invention;

FIG. 6 is a side view of the cleaning brush shown in FIG. 4 according to the present invention; and

FIG. 7 is a top view of a restoring pad for use in the golf grip cleaning/restoring handle and enclosure shown in FIG. 1 according to the present invention.

### DETAILED DESCRIPTION OF THE INVENTION

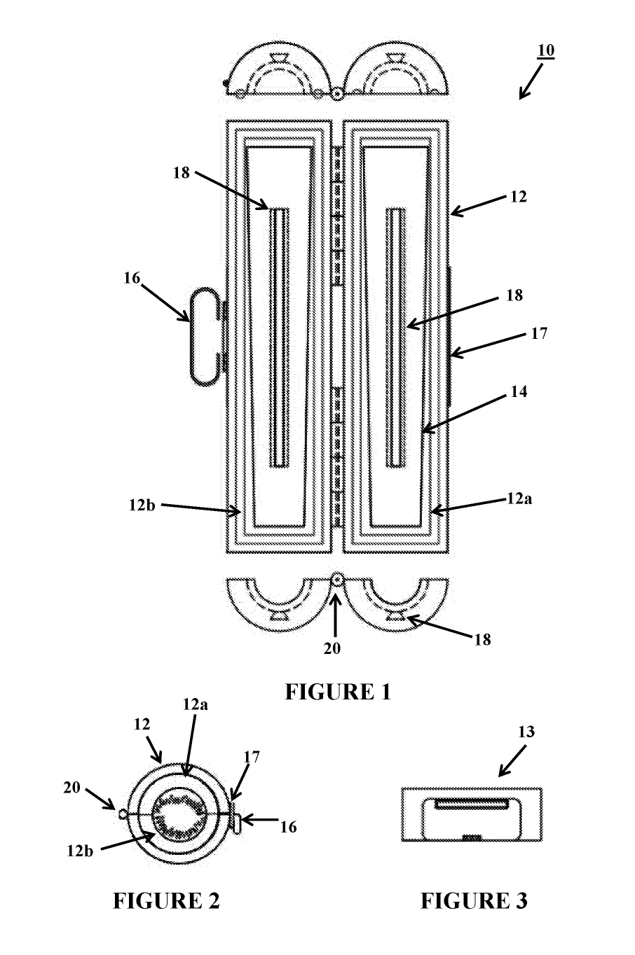

A method and system that is used to periodically clean dirt and oils deposited through normal use from the grip of a golf club that result in a less than desirable grasp of the grip and renew it to a near new condition is disclosed. Referring now to FIG. 1, there is shown and illustrated a handle and enclosure 10 used in the method and system of the present invention for cleaning and/or restoring a golf club grip. The handle in one preferred embodiment is a generally cylindrical housing 12 that splits open lengthwise into two (2) halves 12a and 12b, respectively, that is able to hold a two piece brush or pad insert as will be more fully explained below. The housing 12 may be operatively opened and closed using a set of hinges 20 and in the closed position remains shut using latch 17 and further includes a closure clasp 16 and enclosure 10 between uses as shown in FIG. 2. Referring now to FIG. 3, there is shown another preferred embodiment for a generally rectangularly shaped clasp 13 and enclosure 10 used in the method and system of the present invention for cleaning and/or restoring a golf club grip. In one preferred embodiment, the clasp 13 is a closure clasp mechanism having a clips and spring configuration (not shown) wherein the spring is used to ensure a tight closure by snapping the clips to the ridge on the other half of the enclosures outer casing.

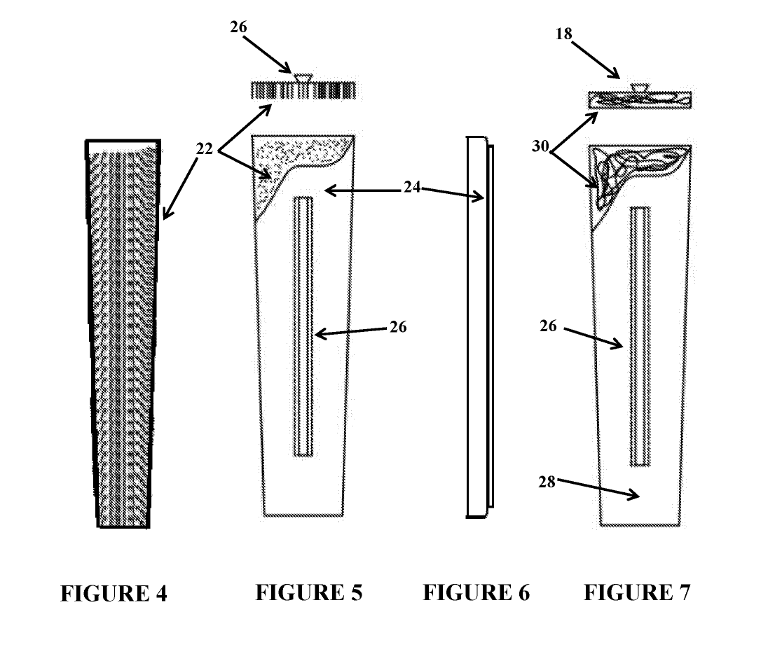

Turning once again to FIG. 1, the interior of housing 14 defines in each of the halves 12a and 12b a centrally located brush and pad retaining channel 18 for receiving and holding a two piece brush or pad insert as will be more fully explained below. The exterior of housing 12 is sized to be slightly longer than a golf grip (not shown) wherein the interior of housing 14 defines an inside diameter when the housing 12 is closed slightly smaller than the outside diameter of a golf grip (not shown). Referring now to FIGS. 4 through 6, there is shown and illustrated a cleaning insert brush 24 used in the method and system of the present invention for cleaning a golf club grip. The cleaning insert brush 24 has a generally trapezoidal or elongated tapered shape and defines a plurality of bristle brushes 22 on the bottom or underneath the cleaning insert brush 24, The top of the cleaning brush defines an elongated ridge 26 made of rubber or other malleable material that is inserted into the retaining channel 18 of housing 12 wherein the size and shape of the retaining channel 18 and ridge 26 allows for the insertion of the cleaning insert brush 24 before use and its extraction after use. The interior of housing 14 of the handle/enclosure 10 will hold soap and water wherein a watertight seal (not shown) is embedded around and near the edges of the inside face of each casing half of the interior of housing 14 to seal in water and soap for use in cleaning grips which is added to the brush insert section prior to commencement of golf grip cleaning, as will be more fully described below. Referring now to FIG. 7, there is shown asnd illustrated a restoring insert pad 28 used in the method and system of the present invention for restoring a golf club grip. The restoring insert pad 28 also has a generally trapezoidal or elongated tapered shape and defines an abrasive pad 30 on the bottom or underneath the restoring insert pad 28, The top of the restoring pad 28 defines the same elongated ridge 26 as cleaning brush 24. It should be understood that the size and shape of restoring insert pad 28 is the same as cleaning insert brush 24.

In accordance with the method of the present invention for cleaning a golf club grip, in use, the housing 12 is split open lengthwise as shown in FIG. 1 wherein a cleaning insert brush 24 is inserted into each halve 12a and 12b therein using the channel 18 and ridge 26 described above. Soapy water is now added to the brush area of each cleaning insert brush 24, wherein a golf grip of a golf club (mounted on a golf club) is laid into the brushes 24, the housing 12 is closed with the golf grip inside the handle/housing 12, the handle/housing 12 is turned 12-15 revolutions. Upon completion of the revolutions, the handle/housing 12 is opened and the golf grip and club are removed from the brushes 24, wherein the golf grip may be washed with clean water and dried with a clean cloth or towel.

The method of the present invention also provides a functional system that restores golf grips in poor condition that are impregnated with dirt and oil and/or have become glazed by removing the oxidized top and sometimes hardened layers from the golf grip and renew it to near new condition. In accordance with the method of the present invention for restoring a golf club grip, in use, the housing 12 is once again split open lengthwise as shown in FIG. 1 wherein a restoring insert pad 28 is inserted into each halve 12a and 12b therein using the channel 18 and ridge 26 described above. a golf grip of a golf club (mounted on a golf club) is laid into the restoring insert pads 28, the housing 12 is closed with the golf grip inside the handle/housing 12, the handle/housing 12 is turned 12-15 revolutions. Upon completion of the revolutions, the handle/housing 12 is opened and the golf grip and club are removed from the restoring insert pads 28, wherein the golf grip may be washed with clean water and is now ready to be cleaned using the method described above with using the cleaning insert brushes 24.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A system for cleaning and restoring a golf club grip of a golf club comprising: a generally elongated housing having a hinge for splitting open said housing lengthwise wherein an interior of said housing defines retaining channels; a generally tapered and trapezoidal cleaning and restoring device defining an elongated centrally located ridge along a back of said device; wherein said device is placed into said housing by inserting said device ridge into said housing channel for holding said device during use and wherein said housing defines a latch allowing said housing to close shut and hold a golf club grip in place during use with said device.

2. The system according to claim 1, wherein said device is a cleaning insert brush used for cleaning the golf club grip.

3. The system according to claim 1, wherein said device is a restoring insert pad used for restoring the golf club grip.

4. The system according to claim 1, wherein said generally elongated housing defines an exterior sized to be slightly longer than the golf grip

5. The system according to claim 1, wherein an interior of said housing defines an inside diameter such that when said housing is closed it is slightly smaller than an outside diameter of the golf grip.

6. The system according to claim 1, wherein said housing further defines a clasp that ensures closure of the said housing.

7. A method for cleaning and restoring a golf club grip of a golf club comprising the steps of:
splitting open lengthwise a generally elongated housing having a hinge wherein an interior of said housing defines retaining channels;
placing a generally tapered and trapezoidal cleaning and restoring device defining an elongated centrally located ridge along a back of said device into said housing by inserting said device ridge into said housing channel for holding said device during use and wherein said housing defines a latch allowing said housing to close shut and hold a golf club grip in place during use with said device.

8. The method according to claim 7, further comprising the step of cleaning the golf club grip when said device is a cleaning insert brush.

9. The method according to claim 7, further comprising the step of restoring the golf club grip when said device is a restoring insert pad.

10. The method according to claim 7, wherein said generally elongated housing defines an exterior sized to be slightly longer than the golf grip.

11. The method according to claim 7, wherein an interior of said housing defines an inside diameter such that when said housing is closed it is slightly smaller than an outside diameter of the golf grip.

12. The method according to claim 7, wherein said housing further defines a clasp that ensures closure of the said housing.
